(19) United States
(12) Patent Application Publication
(10) Pub. No.: US 2026/0227513 A1
(43) Pub. Date: Aug. 6, 2026

(54) MOBILE OBJECT

(71) Applicant: Panasonic Intellectual Property Management Co., Ltd., Osaka (JP)

(72) Inventors: YOSHIKI SASAKI, Osaka (JP); KAZUYA HISADA, Nara (JP); YUMIKO KATO, Osaka (JP)

(21) Appl. No.: 19/460,442

(22) Filed: Jan. 27, 2026

Related U.S. Application Data
(63) Continuation of application No. PCT/JP2024/017920, filed on May 15, 2024.

(30) Foreign Application Priority Data
Aug. 9, 2023 (JP) 2023-130068

(51) Int. Cl. G01S 17/32; G01S 7/48; G01S 7/481; G01S 17/931

(52) U.S. Cl. CPC G01S 17/32; G01S 7/4808; G01S 7/4813; G01S 7/4818; G01S 17/931

(57) ABSTRACT

A mobile object includes a housing, a locomotion assembly that moves the housing, an arm having one end supported by the housing and having at least one joint, a ranging sensor including an optical head, and a controller that controls the locomotion assembly and the arm. The optical head is attached between any one of the at least one joint and a tip of the arm, and the controller causes the ranging sensor to measure a distance to a surrounding area by changing a posture of the arm to change the position of the optical head and controls the locomotion assembly based on three-dimensional spatial information that is obtained based on the distance to the surrounding area measured by the ranging sensor.

### BACKGROUND

### 1. Technical Field

The present disclosure relates to a mobile object.

### 2. Description of the Related Art

Conventionally, LiDAR (Light Detection and Ranging) systems have been disclosed that emit light toward a physical object and measure the distance to the physical object by detecting reflected light from the physical object. For example, Japanese Unexamined Patent Application Publication (Translation of PCT Application) No. 2019-522211 describes that in a distributed FM LiDAR system with a plurality of optical heads, the plurality of optical heads is distributed at appropriate locations external to a mobile object.

### SUMMARY

However, in existing LiDAR systems (ranging devices) described above, reducing the area in which ranging is not possible (blind spot) requires increasing the number of optical heads, which in turn increases the number of constituent elements of the LiDAR systems.

One non-limiting and exemplary embodiment provides a mobile object that can suppress an increase in the number of constituent elements of a ranging device while reducing the area in which ranging is not possible.

In one general aspect, the techniques disclosed here feature a mobile object including a housing, a moving mechanism that moves the housing, an arm having one end supported by the housing and having at least one joint, a ranging device including an optical head, and a control unit that controls the moving mechanism and the arm. The optical head is attached between any one of the at least one joint and a tip of the arm, and the control unit causes the ranging device to measure a distance to a surrounding area by changing a posture of the arm to change a position of the optical head and controls the moving mechanism based on three-dimensional spatial information that is obtained based on the distance to the surrounding area measured by the ranging device.

It should be noted that general or specific embodiments may be implemented as a system, a device, a method, an integrated circuit, a computer program, or a computer-readable recording medium, or any selective combination thereof. Examples of a computer-readable recording medium include a non-transitory recording medium, such as a Compact Disc-Read Only Memory (CD-ROM).

According to the technology of the present disclosure, an increase in the number of constituent elements of a ranging device can be suppressed while reducing the area in which ranging is not possible.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a side view of a mobile object according to an embodiment;

FIG. 2 is a block diagram of the functional configuration of a ranging device according to the embodiment;

FIG. 3 illustrates a flowchart of a method for controlling the mobile object according to the embodiment;

FIG. 4A is a side view of the mobile object according to the embodiment; illustrating a first example of operation performed by the mobile object;

FIG. 4B is a plan view of the mobile object according to the embodiment; illustrating the first example of operation performed by the mobile object;

FIG. 4C is a plan view of the mobile object according to the embodiment; illustrating the first example of operation performed by the mobile object;

FIG. 5A is a side view of the mobile object according to the embodiment; illustrating a second example of operation performed by the mobile object;

FIG. 5B is a plan view of the mobile object according to the embodiment; illustrating the second example of operation performed by the mobile object;

FIG. 6A is a side view of the mobile object according to the embodiment; illustrating a third example of operation performed by the mobile object;

FIG. 6B is a plan view of the mobile object according to the embodiment; illustrating the third example of operation performed by the mobile object;

FIG. 7 is a side view of a mobile object according to a modification of the embodiment; and

FIG. 8 is a side view of a mobile object according to a modification of the embodiment.

### DETAILED DESCRIPTIONS

### Overview of Disclosure

Before describing embodiments in detail, an overview of the present disclosure is provided.

According to a first aspect of the present disclosure, a mobile object includes a housing, a moving mechanism that moves the housing, an arm having one end supported by the housing and having at least one joint, a ranging device including an optical head, and a control unit that controls the moving mechanism and the arm. The optical head is attached between any one of the at least one joint and a tip of the arm, and the control unit causes the ranging device to measure a distance to a surrounding area by changing a posture of the arm to change a position of the optical head and controls the moving mechanism based on three-dimensional spatial information that is obtained based on the distance to the surrounding area measured by the ranging device.

According to the configuration, the position of the optical head can be changed by attaching the optical head to the arm, and the area in which ranging is not possible (that is, blind spot) can be reduced while avoiding an increase in the number of optical heads and/or optical head attachment members. As a result, the amount of three-dimensional spatial information can be increased, which contributes to more sophisticated movement control of the mobile object.

According to a second aspect of the present disclosure, the mobile object is the mobile object according to the first aspect, and the ranging device is a light detection and ranging (LiDAR) device.

This allows the use of a LiDAR device as the ranging device and improves the accuracy of three-dimensional spatial information.

According to a third aspect of the present disclosure, the mobile object is the mobile object according to the second aspect, and the ranging device is a frequency-modulated continuous wave (FMCW) LiDAR device.

This allows the use of an FMCW LiDAR device as the ranging device and further improves the accuracy of three-dimensional spatial information. In addition to measuring the position and shape of a target object, the speed of the target object can be measured, thus enabling advanced control of the mobile object.

According to a fourth aspect of the present disclosure, the mobile object is the mobile object according to any one of the first to third aspects, the ranging device further includes a main unit that is optically connected to the optical head, and the main unit is disposed in the housing.

This allows the optical head and the main unit to be separately disposed on the arm and the housing, respectively. That is, the main unit does not need to be attached to the arm. Therefore, the weight on the arm can be reduced, and the ranging device can be provided even when the arm is smaller. The effect of separating the optical head from the main unit is particularly significant in LiDAR devices, since the main unit tends to be larger. Furthermore, in an FMCW LiDAR device, separating the optical head from the main unit is more effective as ranging errors caused by the separation can be suppressed. Details regarding suppression of ranging errors in the FMCW LiDAR device will be described in a later section regarding FMCW LiDAR.

According to a fifth aspect of the present disclosure, the mobile object is the mobile object according to any one of the first to fourth aspects. The housing has a front surface, a right side surface, and a left side surface, and the surrounding area includes at least one of the front surface, the right side surface, or the left side surface of the housing.

According to this configuration, since the distance to the area including at least one of the front surface, the right side surface, or the left side surface of the housing is measured, an area in which the view is obstructed by the housing can be reduced. In addition, when a physical object (load) is placed on the housing, an overhanging portion projecting from the housing can be detected. As a result, the movement can be controlled based on the size of the overhanging portion of the load, and the overhanging portion of the load can be prevented from contacting a surrounding physical object during movement.

According to a sixth aspect of the present disclosure, the mobile object is the mobile object according to any one of the first to fifth aspects. The control unit controls the arm to assume a first posture and causes the ranging device to measure a distance to a first surrounding area, and the control unit controls the arm to assume a second posture and causes the ranging device to measure a distance to a second surrounding area.

This allows distances to a plurality of surrounding areas to be measured by changing the posture of the arm, and the areas in which ranging is not possible (blind spots) can be reduced without increasing the number of optical heads.

According to a seventh aspect of the present disclosure, the mobile object is the mobile object according to the sixth aspect. The first surrounding area is located in the direction of travel of the mobile object. When a physical object that obstructs the travel of the mobile object is detected in the first surrounding area, the control unit controls the arm to assume the second posture. The second surrounding area is located ahead of the physical object in the direction of travel.

This allows measurement of the distance to the second surrounding area located ahead of the physical object (an obstacle) in the direction of travel of the mobile object. Therefore, the shape of the obstacle can be detected more accurately, and the accuracy of the three-dimensional spatial information can be improved. As a result, advanced movement control based on the shape of the obstacle can be achieved.

According to an eighth aspect of the present disclosure, the mobile object is the mobile object according to any one of the first to seventh aspects. The at least one joint comprises a plurality of joints including a first joint, and the first joint is the joint closest to the tip of the arm of the plurality of joints. The optical head is attached between the first joint and the tip of the arm.

This allows the optical head to be attached closer to the tip of the arm, allowing the optical head to move more freely.

According to a ninth aspect of the present disclosure, the mobile object is the mobile object according to any one of the first to eighth aspects, and the mobile object is an automated guided vehicle (AGV).

This configuration enhances movement control of the AGV.

### EMBODIMENTS

Exemplary embodiments are described in detail below with reference to the accompanying drawings.

Note that each of the embodiments below describes a general or specific example. A value, a shape, a material, a constituent element, the positions and the connection form of the constituent elements, steps, and the sequence of steps used in the embodiments described below are only examples and shall not be construed as limiting the scope of the present disclosure.

All the drawings are schematic and not necessarily drawn to scale. Accordingly, the scale and other details may differ between drawings. In addition, the same reference numerals are used throughout the accompanying drawings to refer to the same or similar constituent elements, and redundant descriptions may be omitted or simplified.

As used herein, the terms describing the positional relationship between elements, such as “parallel” or “perpendicular”, terms describing the shape of an element, such as “circular cylinder” or “rectangular cylinder”, and numerical ranges are not intended to be interpreted in a strict sense, but rather in a broad sense, including substantially equivalent variations (e.g., within a tolerance of several %).

The x- , y- , and z-axes represent the three axes of a three-dimensional Cartesian coordinate system. The x-axis is defined as the axis extending in the direction of travel of the mobile object, and the z-axis is defined as the axis extending in the vertical direction. The positive direction of the x-axis may be referred to as the forward direction, or simply as “forward”, and the negative direction of the x-axis may be referred to as the backward direction, or simply as “backward”. The positive direction of the y-axis may be referred to as the left direction, or simply as “left”, the negative direction of the y-axis may be referred to as the right direction, or simply as “right”. The positive direction of the z-axis may be referred to as the upward direction, or simply as “upward”, and the negative direction of the z-axis may be referred to as a downward direction, or simply as “downward”.

### Configuration of Mobile Object

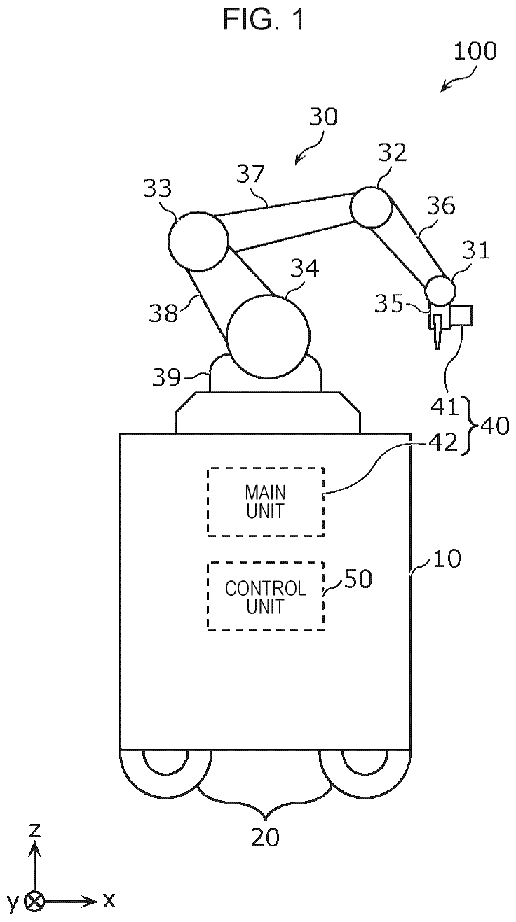

The configuration of a mobile object 100 according to the present embodiment will now be described with reference to FIG. 1. FIG. 1 is a side view of the mobile object 100 according to the present embodiment. FIG. 1 illustrates the exemplary configuration and structure of the mobile object 100, and the configuration and structure of the mobile object 100 are not limited to those illustrated in FIG. 1.

The mobile object 100 is an Automated Guided Vehicle (AGV). The AGV can travel autonomously and is also referred to as an Autonomous Mobile Robot (AMR). The mobile object 100 is not limited to an AGV capable of autonomous travel. For example, the mobile object 100 may be an industrial robot capable of autonomous travel. Alternatively, the mobile object 100 may be a human-driven vehicle, for example.

As illustrated in FIG. 1, the mobile object 100 includes a housing 10, a moving mechanism 20, an arm 30, an end effector 35, a ranging device 40, and a control unit 50.

The housing 10 serves as the main body of the mobile object 100 and houses the control unit 50 and a part of the ranging device 40. As illustrated in FIG. 1, the housing 10 has a cuboid shape.

The moving mechanism 20 can move the housing 10. According to the present embodiment, the moving mechanism 20 is provided in the lower portion of the housing 10 and has, for example, wheels that are rotated and steered by an electric motor (not illustrated). However, the configuration of the moving mechanism 20 is not limited to that illustrated in FIG. 1. For example, the moving mechanism 20 may be a bipedal or quadrupedal mechanism.

The arm 30 is a robotic arm, which can be driven by an actuator (not illustrated), for example, to change its posture. The arm 30 includes a plurality of joints 31 to 34, the end effector 35, a plurality of links 36 to 38, and a base 39.

The joint 31 is the first joint from the tip of the arm 30 in the sequence of the joints 31 to 34. The joint 31 connects the end effector 35 to the link 36, allowing rotational and/or translational movement.

The joint 32 is the second joint from the tip of the arm 30 in the sequence of the joints 31 to 34. The joint 32 connects the link 36 to the link 37, allowing rotational and/or translational movement.

The joint 33 is the third joint from the tip of the arm 30 in the sequence of the joints 31 to 34. The joint 33 connects the link 37 to the link 38, allowing rotational and/or translational movement.

The joint 34 is the fourth joint from the tip of the arm 30 in the sequence of the joints 31 to 34. The joint 34 connects the link 38 to the base 39 so as to be rotatable about y-axis and/or translationally displaceable.

The end effector 35, sometimes referred to as a robot hand, serves as the tip of the arm 30. The end effector 35 is connected to the link 36 by the joint 31 in a manner that allows rotational and/or translational movement. The end effector 35 has an optical head 41 of the ranging device 40 (described below) attached thereto. The end effector 35 only needs to support the mounting of the optical head 41 and does not need to grasp a physical object.

The link 36 is connected to the end effector 35 by the joint 31 in a manner that allows rotational movement. In addition, the link 36 is connected to the link 37 by the joint 32 in a manner that allows rotational and/or translational movement.

The link 37 is connected to the link 36 by the joint 32 in a manner that allows rotational movement. In addition, the link 37 is connected to the link 38 by the joint 33 in a manner that allows rotational and/or translational movement.

The link 38 is connected to the link 37 by the joint 33 in a manner that allows rotational movement. In addition, the link 38 is connected to the base 39 by the joint 34 in a manner that allows rotational and/or translational movement.

The base 39 is connected to the housing 10 in a manner that allows rotational and/or translational movement.

The configuration of the arm 30 is not limited to that illustrated in FIG. 1. For example, the number of joints of the arm 30 may be selected from one, two, three, or five or more.

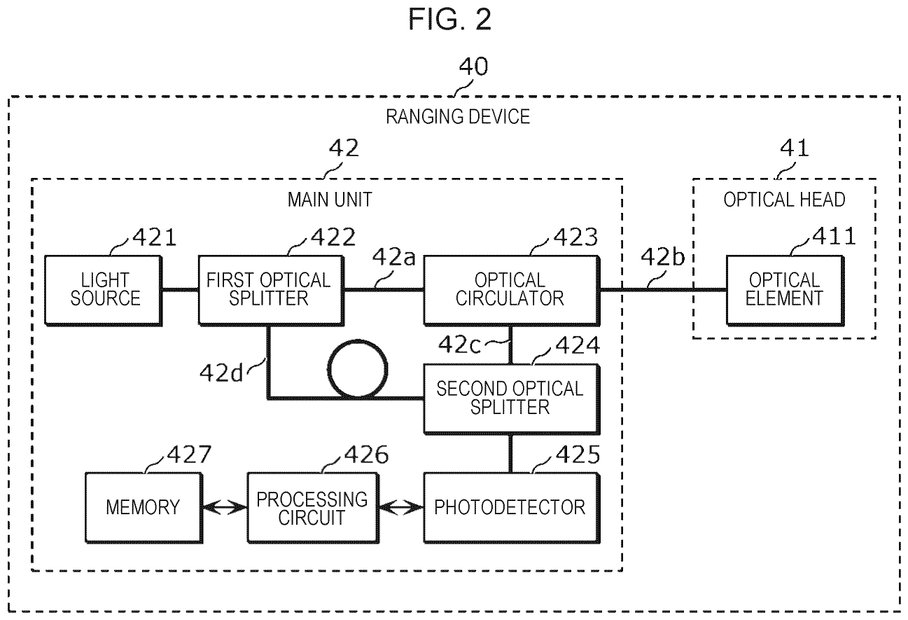

The ranging device 40 includes the optical head 41 and a main unit 42, which can measure the distance to the surrounding area of the mobile object 100. Measuring the distance to an area refers to measuring the distance from the ranging device 40 to a physical object located within the area. The ranging device 40 is, for example, a frequency-modulated continuous wave (FMCW) LiDAR device. The ranging device 40 is described in more detail below with reference to FIG. 2.

The ranging device 40 is not limited to an FMCW LiDAR device, but may be a ToF (Time of Flight) LiDAR device, for example. In addition, the ranging device 40 is not limited to a LiDAR device, and may include other devices such as stereo cameras, radar, or ultrasonic sensors.

The optical head 41 is disposed remotely from the main unit 42 and is attached to the end effector 35. The main unit 42 is disposed within the housing 10 and is optically connected to the optical head 41.

The arrangement of the optical head 41 and the main unit 42 is not limited to that illustrated in FIG. 1. For example, the optical head 41 may be integrated with the main unit 42. In this case, both the optical head 41 and the main unit 42 may be attached to the end effector 35. The mounting position of the optical head 41 is not limited to the end effector 35. For example, the optical head 41 may be attached to any one of the links 36 to 38 or the joints 31 to 33. That is, the optical head 41 can be attached between any one of the plurality of joints 31 to 34 and the tip of the arm 30. More specifically, the optical head 41 can be disposed anywhere on the arm 30 between the joint 34 and the tip in the direction along the arm 30.

The control unit 50 can control the moving mechanism 20 and the arm 30. For example, the control unit 50 can generate control signals to drive the moving mechanism 20 and control signals to control the posture of the arm 30.

All or some of the functions or operations of the control unit 50 may be performed by one or more electronic circuits that include, for example, a semiconductor device, a semiconductor integrated circuit (IC), or a large scale integration (LSI) circuit. The LSI circuit or IC may be composed as a single chip or a plurality of chips. The term “LSI circuit” and “IC” are used herein, but the term “system LSI circuit”, “VLSI (very large scale integration) circuit” or “ultra LSI circuit” may be used as well depending on the level of integration. A field programmable gate array (FPGA), which is programmed after the LSI chip is manufactured, or a reconfigurable logic device (RLD), which can reconfigure the junction relationships inside the LSI chip or set up the circuit partitions inside the LSI chip, can be used for the same purpose.

All or some of the functions or operations of the control unit 50 may be performed through software processing. In this case, the software is recorded on one or more non-transitory recording media, such as read only memories (ROMs), optical disks, and hard disk drives, and when the software is executed by a processing device (processor), the function identified by the software is performed by the processing device and a peripheral device. The system or device may be equipped with one or more non-transitory recording media that store the software, the processing device, and any necessary hardware devices (for example, interfaces).

### Configuration of Ranging Device

The configuration of the ranging device 40 is described below with reference to FIG. 2. FIG. 2 is a block diagram of the functional configuration of the ranging device 40 according to the present embodiment, illustrating an exemplary functional configuration of the ranging device 40. However, the functional configuration of the ranging device 40 is not limited to that illustrated in FIG. 2.

The ranging device 40 includes the optical head 41 and the main unit 42. The optical head 41 includes an optical element 411. The main unit 42 includes a light source 421, a first optical splitter 422, an optical circulator 423, a second optical splitter 424, a photodetector 425, a processing circuit 426, and a memory 427.

The light source 421 can emit a laser beam to the first optical splitter 422. The laser beam emitted from the light source 421 is an FMCW laser beam having a frequency that varies in a periodic manner. The light source 421 is not necessarily included in the main unit 42.

The first optical splitter 422 is optically connected to the optical circulator 423 via an optical fiber 42a and to the second optical splitter 424 via the optical fiber 42d. The first optical splitter 422 can split the laser beam emitted from the light source 421 into a measurement light and a reference light, which are emitted to the optical circulator 423 and the second optical splitter 424, respectively.

The optical circulator 423 is optically connected to the first optical splitter 422 via the optical fiber 42a, to the optical element 411 (described below) via an optical fiber 42b, and to the second optical splitter 424 via an optical fiber 42c. The optical circulator 423 can emit the measurement light input from the first optical splitter 422 to the optical element 411. Furthermore, the optical circulator 423 can output reflected light input from the optical element 411 to the second optical splitter 424. The optical circulator 423 is not necessarily included in the main unit 42.

The optical element 411 is connected to the optical circulator 423 via the optical fiber 42b. The optical element 411 can emit the measurement light input from the optical circulator 423 to the surrounding area of the mobile object 100. Furthermore, the optical element 411 can receive reflected light from the surrounding area and emit the light to the optical circulator 423. The optical element 411 can include a collimator lens and collimate the measurement light. The optical element 411 may include a galvanometer mirror and scan the measurement light. The optical element 411 may include another scanning mechanism instead of a galvanometer mirror. The optical element 411 need not include a scanning mechanism. In this case, scanning of the measurement light may be performed by the arm 30. The scanning of the measurement light is not necessarily performed.

The second optical splitter 424 is connected to the optical circulator 423 via the optical fiber 42c and to the first optical splitter 422 via the optical fiber 42d. The second optical splitter 424 can combine the reference light input from the first optical splitter 422 and the reflected light input from the optical circulator 423 and emit a composite light to the photodetector 425. The second optical splitter 424 is not necessarily included in the main unit 42.

The photodetector 425 can detect the composite light input from the second optical splitter 424. The photodetector 425 includes one or more photodetection elements that output an electrical signal corresponding to the intensity of the composite light. The photodetector 425 is not necessarily included in the main unit 42.

The processing circuit 426 can control the operation performed by the light source 421 and the photodetector 425. Furthermore, the processing circuit 426 can generate and output data indicating the distance and/or speed of a physical object located in the surrounding area of the mobile object 100 by processing the signals output from the photodetector 425 using FMCW LiDAR technology.

The computer program to be executed by the processing circuit 426 is stored in the memory 427. The processing circuit 426 and the memory 427 may be integrated on a single circuit board or may be mounted on separate circuit boards. The processing circuit 426 may also be distributed across a plurality of circuits. The processing circuit 426 and the memory 427 need not be included in the main unit 42. In this case, instead of the processing circuit 426, control and signal processing may be performed by one or more computers connected to the ranging device 40 via a wired or wireless communication network.

### FMCW LiDAR

The FMCW LiDAR is described below. In FMCW LiDAR, FMCW light is split into a measurement light and a reference light, and the measurement light is emitted to a physical object. The distance to the physical object is measured based on the difference in frequency between the reflected light from the physical object and the reference light.

If the following equation (1) holds, the distance from the optical head 41 to the physical object can be measured by the ranging device 40:

$$d = a + 2 b + c , \qquad ( 1 )$$

where “a” represents the optical path length through the optical fiber 42a between the first optical splitter 422 and the optical circulator 423, “b” represents the optical path length through the optical fiber 42b between the optical circulator 423 and the optical element 411, “c” represents the optical path length through the optical fiber 42c between the optical circulator 423 and the second optical splitter 424, and “d” represents the optical path length through the optical fiber 42d between the first optical splitter 422 and the second optical splitter 424.

As described above, in FMCW LiDAR, “a+2b+c” is the sum of the optical path length (a+b) of the measurement light from the first optical splitter 422 to the optical element 411 and the optical path length (b+c) of the reflected light from the optical element 411 to the second optical splitter 424. By making the optical path length (a+2b+c) equal to the optical path length (d) of the reference light from the first optical splitter 422 to the second optical splitter 424, the optical path lengths of the measurement light and the reflected light can be cancelled out by the optical path length of the reference light within the ranging device 40. Thus, the distance from the optical head 41 (the optical element 411) to the physical object can be measured.

In general, the refractive index of an optical fiber varies with temperature. That is, the optical path length of an optical fiber varies with temperature. As a result, the measurement result of the distance to a physical object is affected by the temperature variation of the optical path length of the optical fiber, and the influence increases with increasing optical path length in the ranging device 40.

For example, in ToF LiDAR, to obtain the distance from the optical head to a physical object, the optical path length between the light source and the optical head needs to be subtracted from the measurement result (the distance from the light source to the physical object). However, as described above, the optical path length of an optical fiber varies with temperature, making it difficult to accurately subtract the optical path length between the light source and the optical head. That is, in ToF LiDAR, an increase in the optical path length resulting from the separate arrangement of the main unit 42 and the optical head 41 may increase ranging errors.

In FMCW LiDAR, since the optical path length of the reference light in the ranging device 40 varies similarly to those of the measurement light and reflected light in the ranging device 40 under temperature change, the influence of temperature-induced variation of the optical path length is effectively canceled out. Therefore, in FMCW LiDAR, the increase in ranging errors caused by the increase in optical path length due to the separate arrangement of the main unit 42 and the optical head 41 can be reduced.

### Method for Controlling Mobile Object

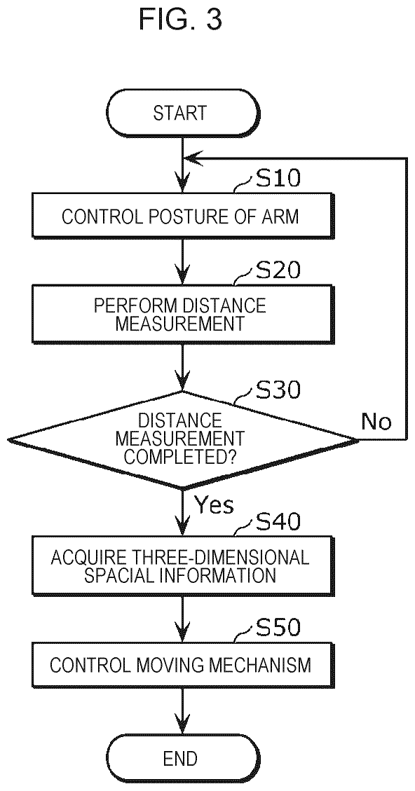

The method for controlling the mobile object 100 is described below with reference to FIG. 3. FIG. 3 illustrates a flowchart of the method for controlling the mobile object 100 according to the present embodiment.

### Step S10

The control unit 50 controls the posture of the arm 30. More specifically, the control unit 50 controls the posture of the arm 30 to place the optical head 41 in a position and orientation suitable for distance measurement in the surrounding area of the mobile object 100.

### Step S20

The ranging device 40 measures the distance to the surrounding area of the mobile object 100. As a result, data indicating the distance and/or speed of the physical object located in the surrounding area of the mobile object 100 is stored in the memory 427.

### Step S30

The control unit 50 determines whether distance measurement performed by the ranging device 40 has been completed. For example, the control unit 50 determines whether the distance measurements have been completed for all of predetermined surrounding areas of the mobile object 100. If it is determined that the distance measurement has not been completed (No in step S30), the processing returns to step S10. However, if it is determined that distance measurement has been completed (Yes in step S30), the processing proceeds to step S40.

### Step S40

The control unit 50 acquires three-dimensional spatial information. The three-dimensional spatial information indicates a physical object that is present in a surrounding area of the mobile object 100 in three-dimensional space. The three-dimensional spatial information is generated, for example, by the control unit 50 or the ranging device 40 based on the distance to the surrounding area measured by the ranging device 40. Alternatively, the three-dimensional spatial information may be generated by a computer external to the mobile object 100.

### Step S50

The control unit 50 controls the moving mechanism 20 based on the acquired three-dimensional spatial information. For example, if the three-dimensional spatial information indicates the presence of an obstacle, the control unit 50 controls the moving mechanism 20 to avoid the obstacle while traveling. That is, the control unit 50 enables automated driving based on the three-dimensional spatial information.

### EXAMPLES OF OPERATION BY MOBILE OBJECT

Several examples of operation performed by the mobile object 100 are described below with reference to the accompanying drawings.

### First Example of Operation

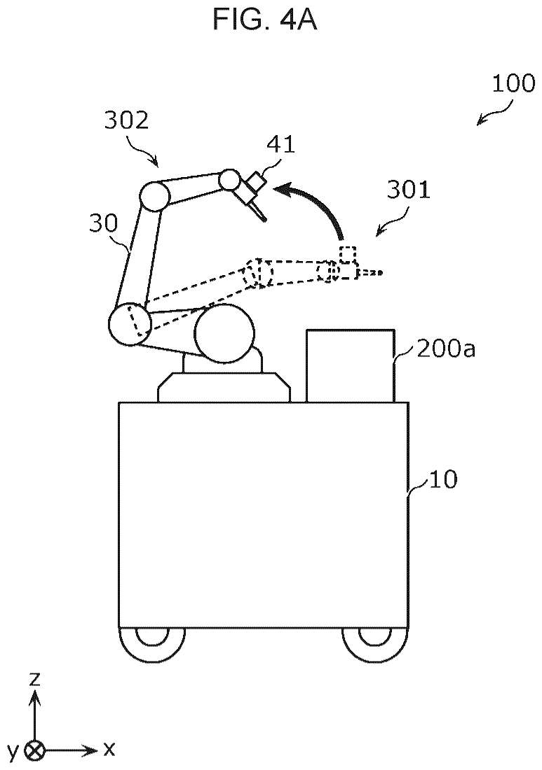

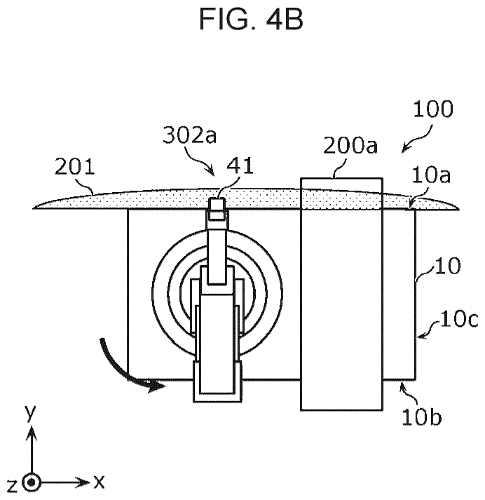

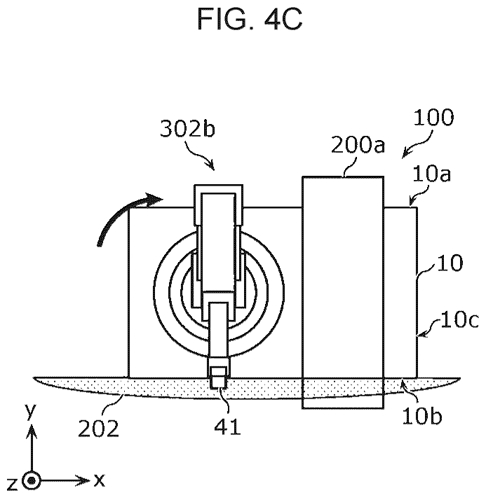

The first example of operation will now be described with reference to FIGS. 4A, 4B, and 4C. FIG. 4A is a side view and FIGS. 4B and 4C are plan views of the mobile object 100 according to the present embodiment, illustrating the first example of operation performed by the mobile object 100. The first example of operation is performed by the mobile object 100 after a physical object 200a is placed on the top surface of the housing 10 of the mobile object 100.

The control unit 50 of the mobile object 100 changes the posture of the arm 30 from posture 301 to posture 302a and/or 302b. More specifically, as illustrated in FIG. 4A, the control unit 50 first controls the arm 30 to assume posture 302 by moving the tip of the arm 30 upward and backward. Then, as illustrated in FIG. 4B, the control unit 50 rotates the base 39 of the arm 30 counterclockwise to move the optical head 41 to a position where the ranging device 40 can measure the distance to a surrounding area 201 including a left side surface 10a of the housing 10. Alternatively, as illustrated in FIG. 4C, the control unit 50 rotates the base 39 of the arm 30 clockwise to move the optical head 41 to a position where the ranging device 40 can measure the distance to a surrounding area 202 including a right side surface 10b of the housing 10.

As described above, the control unit 50 can control the arm 30 to assume posture 302a and/or 302b and cause the ranging device 40 to measure the distance to the surrounding area 201 including the left side surface 10a of the housing 10 and/or the surrounding area 202 including the right side surface 10b of the housing 10. This allows detection of an overhanging portion of the physical object 200a that projects from the housing 10 when the physical object 200a is placed on the housing 10. As a result, the movement of the mobile object 100 can be controlled based on the size of the overhanging portion of the physical object 200a, and the overhanging portion of the physical object 200a can be prevented from contacting another surrounding physical object during movement.

Although not illustrated in FIGS. 4A to 4C, the control unit 50 may move the optical head 41 to a position where the ranging device 40 can measure the distance to the surrounding area including a front surface 10c of the housing 10.

The first example of operation is not limited to being applied after the object 200a is placed on the top surface of the housing 10 of the mobile object 100. For example, the first example of operation may be applied before the mobile object 100 that is stationary starts to move.

### Second Example of Operation

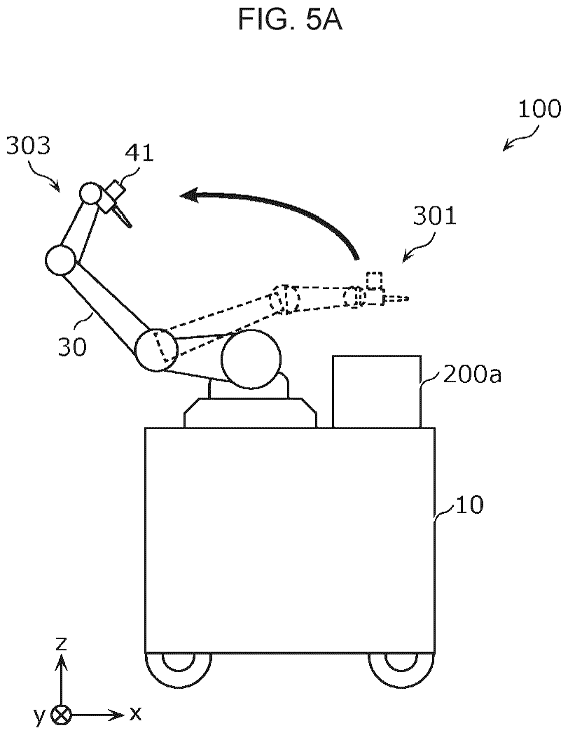

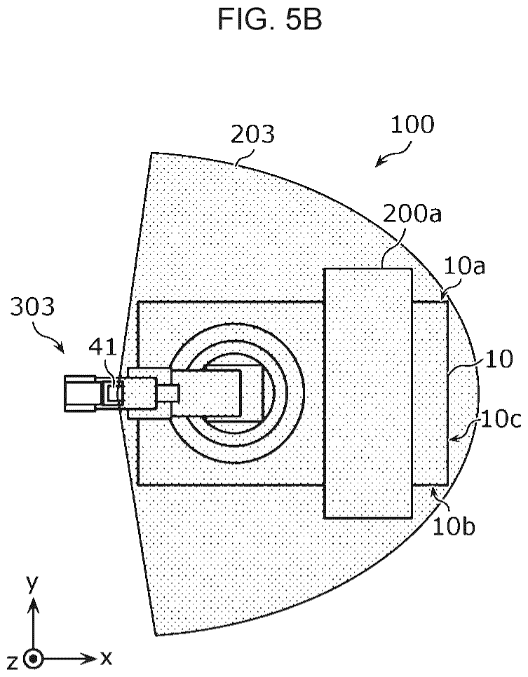

The second example of operation is described below with reference to FIGS. 5A and 5B. FIGS. 5A and 5B are a side view and a plan view of the mobile object 100 according to the present embodiment, respectively, illustrating the second example of operation performed by the mobile object 100. Like the first example of operation, the second example of operation is described with reference to the operation performed by the mobile object 100 after the physical object 200a is placed on the top surface of the housing 10 of the mobile object 100.

The control unit 50 of the mobile object 100 changes the posture of the arm 30 from posture 301 to posture 303. More specifically, as illustrated in FIGS. 5A and 5B, the control unit 50 controls the arm 30 to assume posture 303 by moving the tip of the arm 30 significantly upward and backward. This moves the optical head 41 to a position where the ranging device 40 can measure the distance to a surrounding area 203 including the left side surface 10a, the right side surface 10b, and the front surface 10c of the housing 10. That is, the control unit 50 controls the arm 30 to assume posture 303 and causes the ranging device 40 to measure the distance to the surrounding area 203 that includes the front surface 10c, the right side surface 10b, and the left side surface 10a of the housing 10. This allows detection of an overhanging portion of the physical object 200a, which projects from the housing 10 when placed on the housing 10. As a result, the movement of the mobile object 100 can be controlled based on the size of the overhanging portion of the physical object 200a, and the overhanging portion of the physical object 200a can be prevented from contacting any surrounding object during movement.

Like the first example of operation, the second example of operation is not limited to being applied after the physical object 200a is placed on the top surface of the housing 10 of the mobile object 100. For example, the second example of operation may be applied before the mobile object 100 that is stationary starts to move.

### Third Example of Operation

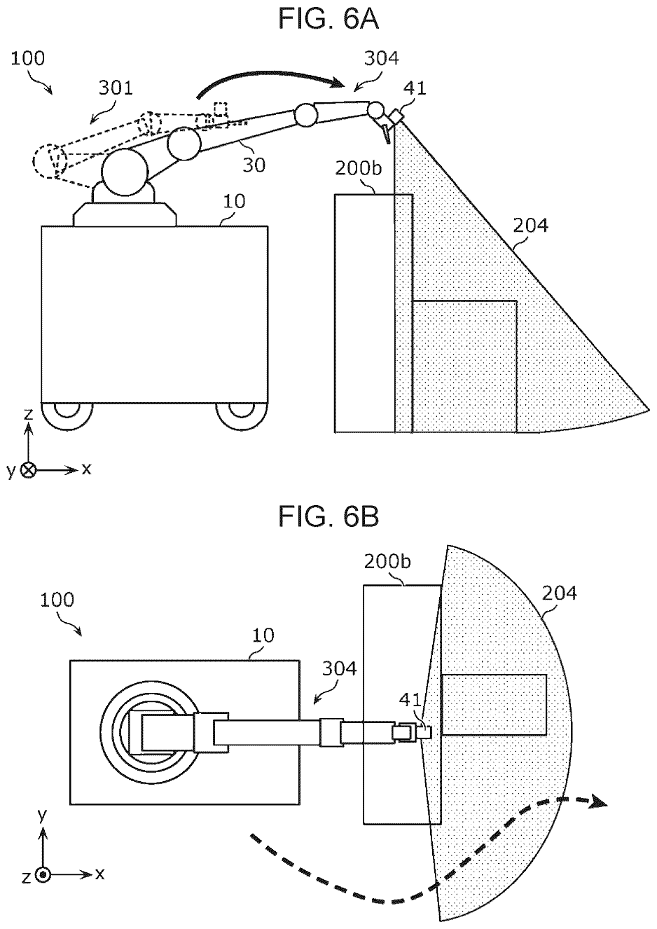

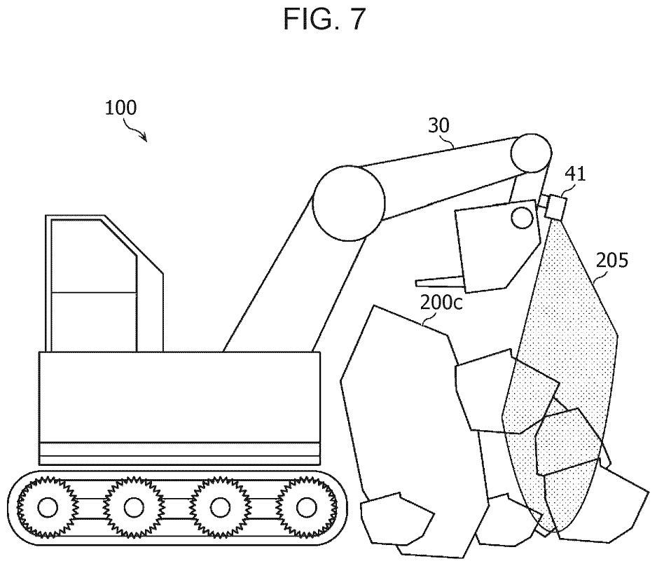

The third example of operation is described below with reference to FIGS. 6A and 6B. FIGS. 6A and 6B are a side view and a plan view of the mobile object 100 according to the present embodiment, respectively, illustrating the third example of operation performed by the mobile object 100. The third example of operation is described with reference to an operation performed by the mobile object 100 after the mobile object 100 detects a physical object 200b along its direction of travel while in motion.

The control unit 50 of the mobile object 100 changes the posture of the arm 30 from posture 301 to posture 304. More specifically, as illustrated in FIGS. 6A and 6B, the control unit 50 controls the arm 30 to assume posture 304 by moving the tip of the arm 30 significantly forward. As a result, the optical head 41 is moved to a position where the ranging device 40 can measure the distance to a surrounding area 204 located ahead of the physical object 200b in the x-direction. That is, the control unit 50 controls the arm 30 to assume posture 304 and causes the ranging device 40 to measure the distance to the surrounding area 204 located ahead of the physical object 200b in the x-direction. Thus, the distance to the surrounding area 204 ahead of the physical object 200b (an obstacle) in the direction of travel of the mobile object 100 is measured. Therefore, the shape of the physical object 200b can be detected more accurately, and the accuracy of the three-dimensional spatial information can be improved. As a result, a higher level of movement control can be achieved based on the shape of the physical object 200b. For example, the movement of the mobile object 100, as represented by the dashed arrow in FIG. 6B, can be performed.

### Modifications

While the mobile object has been described with reference to the embodiment, the mobile object of the present disclosure is not limited thereto. Other embodiments obtained by combining any constituent elements of the above-described embodiment and various modifications which those skilled in the art can conceive within the spirit and scope of the present disclosure are also encompassed in the present disclosure.

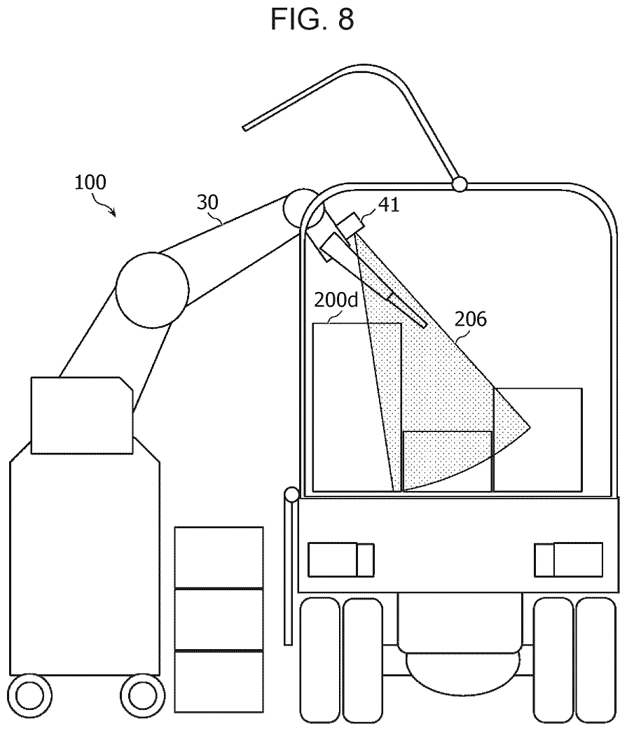

For example, the mobile object 100 according to the above-described embodiment is an AGV, but is not limited thereto. For example, as illustrated in FIG. 7, the mobile object 100 may be a loading shovel. Even in such a case, the mobile object 100 can measure the distance to a surrounding area 205 located behind a physical object 200c using the optical head 41 attached between the joint and the tip of the arm 30.

Furthermore, as illustrated in FIG. 8, the mobile object 100 may be a loading and unloading robot that automatically performs loading and unloading of trucks. Even in such a case, the mobile object 100 can measure the distance to a surrounding area 206 located behind a physical object 200d using the optical head 41 attached between the joint and the tip of the arm 30.

While the above-described embodiment has been described with reference to the optical fibers 42a, 42b, 42c, and 42d used to optically connect the constituent elements of the ranging device 40, the present embodiment is not limited thereto. Some or all of the optical fibers 42a, 42b, 42c, and 42d may be replaced by optical waveguides. While the above-described embodiment has been described with reference to the optical fiber 42b that optically connects the optical circulator 423 to the optical element 411 and is shared for both the measurement light and reflected light, separate optical fibers may be used for the measurement light and reflected light.

In the above-described embodiments, the mobile object 100 is automatically driven based on the three-dimensional spatial information. However, the mobile object 100 may alternatively be driven manually by the driver.

The present disclosure is applicable to mobile objects equipped with a ranging device, such as AGVs.

What is claimed is:

1. A mobile object comprising:
a housing;
a locomotion assembly that moves the housing;
an arm having one end supported by the housing and having at least one joint;
a ranging sensor including an optical head; and
a controller that controls the locomotion assembly and the arm,
wherein the optical head is attached between any one of the at least one joint and a tip of the arm, and
wherein the controller causes the ranging sensor to measure a distance to a surrounding area by changing a posture of the arm to change a position of the optical head and controls the locomotion assembly based on three-dimensional spatial information that is obtained based on the distance to the surrounding area measured by the ranging sensor.

2. The mobile object according to claim 1, wherein the ranging sensor is a light detection and ranging (LiDAR) sensor.

3. The mobile object according to claim 2, wherein the ranging sensor is a frequency-modulated continuous wave (FMCW) LiDAR sensor.

4. The mobile object according to claim 1, wherein the ranging sensor further includes a main unit that is optically connected to the optical head, and
wherein the main unit is disposed in the housing.

5. The mobile object according to claim 1, wherein the housing has a front surface, a right side surface, and a left side surface, and
wherein the surrounding area includes at least one of the front surface, the right side surface, or the left side surface of the housing.

6. The mobile object according to claim 1, wherein the controller controls the arm to assume a first posture and causes the ranging sensor to measure a distance to a first surrounding area, and
wherein the controller controls the arm to assume a second posture and causes the ranging sensor to measure a distance to a second surrounding area.

7. The mobile object according to claim 6, wherein the first surrounding area is located in a direction of travel of the mobile object,
wherein when a physical object that obstructs the travel of the mobile object is detected in the first surrounding area, the controller controls the arm to assume the second posture, and
wherein the second surrounding area is located ahead of the physical object in the direction of travel.

8. The mobile object according to claim 1, wherein the at least one joint comprises a plurality of joints including a first joint, and the first joint is closest to the tip of the arm of the plurality of joints, and
wherein the optical head is attached between the first joint and the tip of the arm.

9. The mobile object according to claim 1, wherein the mobile object is an automated guided vehicle (AGV).
